(19) United States
(12) Patent Application Publication
(10) Pub. No.: US 2007/0230369 A1
(43) Pub. Date: Oct. 4, 2007

(54) Route selection in a network

(76) Inventor: Gary L. McAlpine, Banks, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/395,011

(22) Filed: Mar. 31, 2006

(51) Int. Cl. H04L 12/28

(52) U.S. Cl. 370/256

(57) ABSTRACT

An input port of a switch in a network receives a discover packet specifying an address of an endpoint in the network, selects one of a spanning-tree-protocol (STP) route or an alternate route from the switch to the endpoint, and forwards the discover packet to an output port of the switch corresponding to the selected route.

This application is related to application Ser. No. 11/354,624, titled Traffic Rate Control in a Network, filed Feb. 14, 2006, which is a continuation-in-part of application Ser. No. 11/322,961, titled Traffic Rate Control in a Network, filed Dec. 30, 2005. Additionally, this application is related to patent application Ser. No. 11/114,641 filed on Apr. 25, 2005, titled Congestion Control in a Network.

### TECHNICAL FIELD

Embodiments of the invention relate to data communication. In particular, embodiments relate to a packet switching device in a layer 2 sub-network (“subnet”) selecting one of multiple routes in the subnet over which to transmit data traffic directed to an endpoint at the edge of the subnet.

### BACKGROUND

Ethernet is typically used as a local area network (LAN) technology, but may be used in switching fabrics, datacenter, cluster, and blade system interconnects, and Storage Area Networks (SAN) as well. (Reference herein to “Ethernet” encompasses the standards for CSMA/CD (Ethernet) based LANs, including the standards defined in the IEEE802.3™-2002, Part 3 Carrier sense multiple access with collision detection (CSMA/CD) access method and physical layer specification, as well other related standards, study groups, projects, and task forces under IEEE 802, including IEEE 802.1D-2004 on Media Access Control (MAC) Bridges).

Current IEEE standards incorporate a Spanning Tree Protocol (STP) to control routing of data packets to prevent duplicate copies of the data packets from being sent over redundant routes. In particular, STP configures an arbitrary network topology into a spanning-tree that provides at most one open or active route between any two endpoints in a layer 2 subnetwork. STP blocks redundant paths in the network, which limits the ability to scale switched Ethernet network bandwidth using these redundant paths to handle unicast data packet traffic. The term data packet, or simply, packet, is used herein to mean a unit of information comprising a header, data, and a trailer, that can be transmitted across a communication medium, for example, a wire or radio frequency, in a computer or telecommunications network. A packet commonly may be referred to as a datagram, cell, segment, or frame, and it is understood that these terms can be used interchangeably with the term packet.

### BRIEF DESCRIPTION OF THE DRAWINGS

In the accompanying figures:

FIG. 1 is a block diagram of a node in accordance with an embodiment of the invention.

FIG. 2 is a diagram of an example packet format as may be used to transmit layer 2 control information in an embodiment of the invention.

FIG. 3 is a network diagram in which an embodiment of the invention may be used.

FIG. 4 is a network diagram of a network architecture in which an embodiment of the invention may be implemented.

FIG. 5 is a flow diagram of an embodiment of the invention.

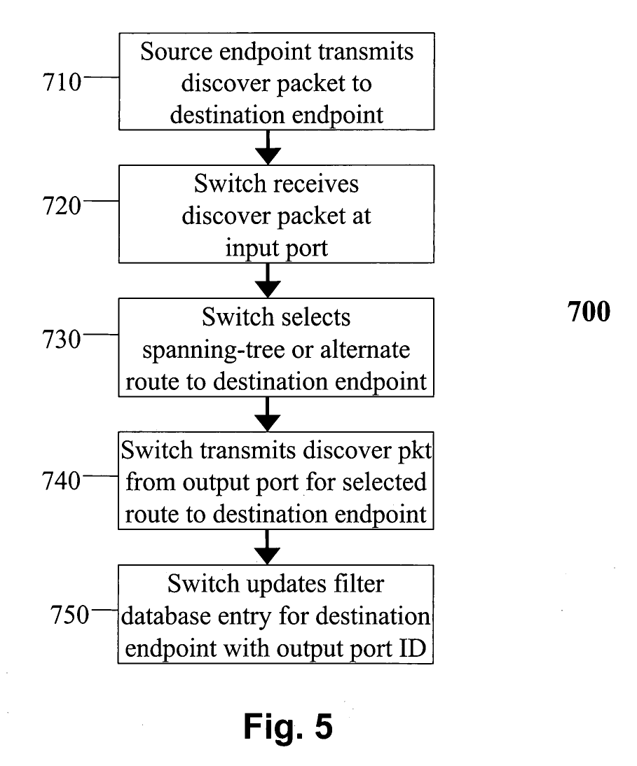

FIG. 6 is a flow diagram of an embodiment of the invention.

### DETAILED DESCRIPTION

Embodiments of the invention utilizes Ethernet-based layer 2, or subnet level, mechanisms, including congestion management (CM) mechanisms, implemented in hardware and/or software, that operate with existing upper layer (layer 3 or higher) CM mechanisms and layer 1, or link layer, flow control mechanisms. In one embodiment, a Path Rate Control (PRC) mechanism (simply, “PRC”) is supported by a layer 2 control protocol (L2CP) for finding and establishing a path among a plurality of routes in a switched sub-network, and collecting layer 2 path information. The path information is used by PRC to dynamically control the flow of traffic at the ingress of a layer 2 subnet, such as a switched interconnect.

A node, at a layer 2 endpoint, or edge of a subnet, that receives data traffic from higher layers and transmits the data traffic into a subnet is a source, ingress, or ingress node, of the subnet, whereas an endpoint node that receives data traffic from the subnet for processing or forwarding to another subnet is a destination, egress, or egress node of the subnet. Additionally, a path through the subnet may be defined by a Media Access Control (MAC) address of the destination, from the perspective of a source node. One or more routes in the subnet exist between the source node and destination node. A path is a selected route over which data traffic is transmitted from the source node to the destination node.

An Ethernet subnet, for example, within a datacenter network, may interconnect a set of equipment or blades in a chassis or racks, into a single system that provides services to both internal clients (within the datacenter) and external clients (outside the datacenter). In such a system, each layer 2 subnet may switch a wide variety of network traffic, as well as local storage and cluster communications. In one embodiment of the invention, a Path Rate Control Interface (PRCI) on or associated with each node or blade interface into or out of the subnet effectively creates a shell around the layer 2 subnet. Inside the shell, the congestion mechanisms provide congestion feedback to the edges of the subnet and enable regulation of traffic flow into the subnet. In one embodiment, traffic entering the subnet is dynamically regulated so as to avoid overloading the points where traffic converges, thereby avoiding the need to drop packets while maintaining high throughput efficiency. In addition, regulation of the traffic at the endpoints, or edges, of the subnet may cause queues above layer 2 (e.g., flow queues) to get backlogged, causing backpressure in the upper layers of the stack. This backpressure may be used to trigger upper layer congestion control mechanisms, without dropping packets within the layer 2 subnet.

Path Rate Control Interface

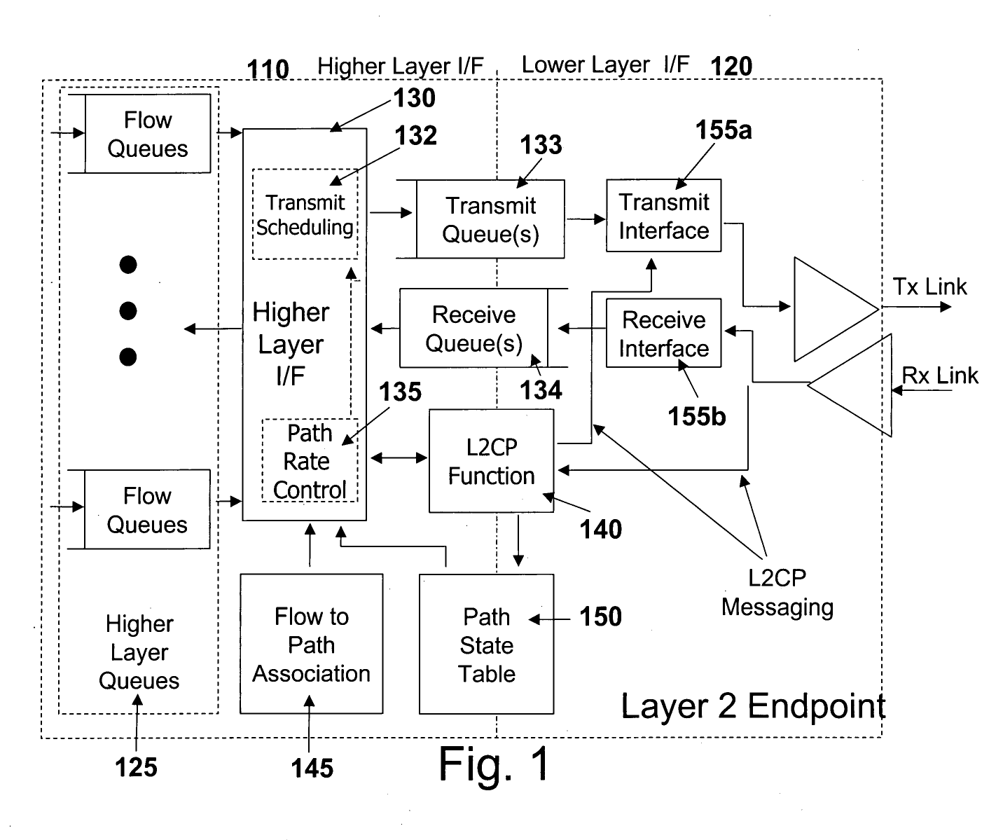

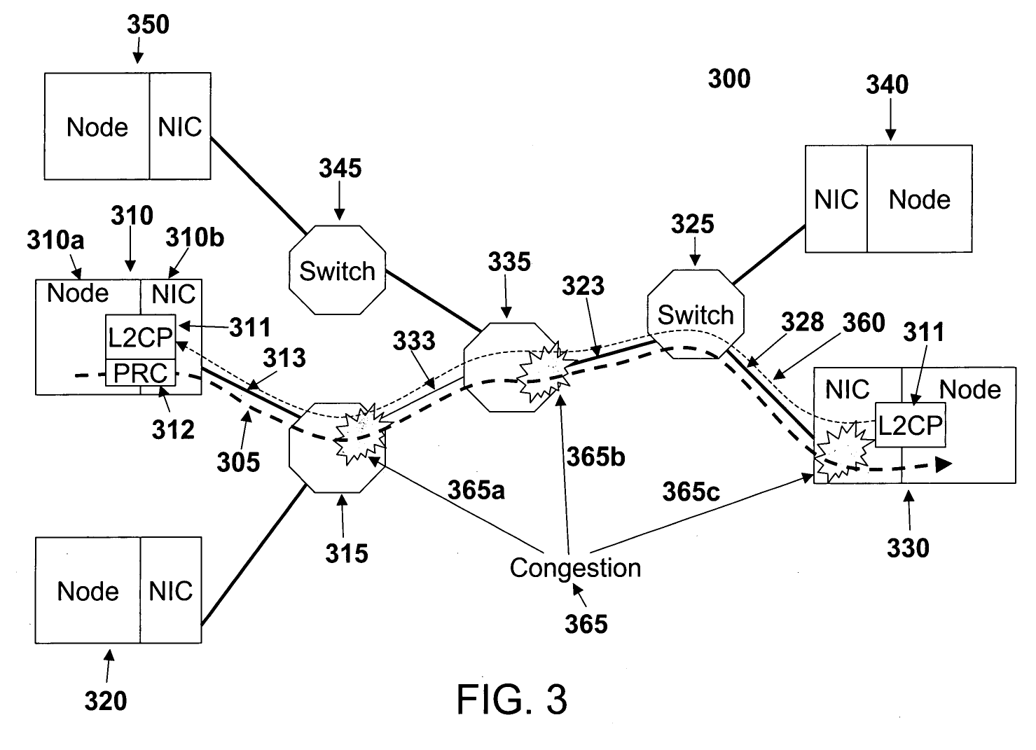

With reference to FIG. 1, in one embodiment of the invention, a Path Rate Control Interface is implemented between the layer 2 components (120) and higher layer (e.g. layers above layer 2) components (110) in a node. The PRCI comprises a Layer 2 Control Protocol (L2CP) function module 140 for generating and receiving L2CP messages and for maintaining path state information, a path state table 150 for interfacing path state information to a higher layer interface 130, and a path rate control (PRC) function module 135 that supports dynamic scheduling of higher layer flows or flow bundles from higher layer transmit queues 125 into the lower layer transmit queue(s) 133 based on path specific congestion and state information. The PRC function module also provides support for an extended Spanning Tree Routing protocol, as described below. Note that the PRC function does not control the rate of data traffic. Rather, it provides information that can be used by a transmit scheduler 132 for dynamically rate controlling traffic to the layer 2 subnet. One embodiment of the PRCI implements the layer 2 functionality primarily in hardware and the higher layer functionality in a combination of hardware, firmware, and/or driver level software. The higher layer functionality may utilize existing address translation tables 145 to associate flows with paths. (A path may be defined by a destination MAC address from a given source MAC perspective. A unique communication path exists between any two nodes at the edges of the subnetwork. For example, with reference to FIG. 3, a unique communication path exists between nodes 310 and 330, by way of link 313, switch 315, link 333, switch 335, link 323, switch 325 and link 328.)

The L2CP function module 140 automatically discovers and selects a unique path from a number of routes through the subnet to a particular destination endpoint and supplies congestion and rate control information about the path to the PRC function module 135 through the path state table 150, and provides support for the extended Spanning Tree Protocol, as discussed below. This information enables module 135 to supply dynamic rate control information to transmit scheduler 132 for congestion control at the subnet level. Transmit scheduler 132 may selectively use the dynamic rate control information to optimize the scheduling of higher layer flows or flow bundles from queues 125 into lower layer transmit queues 133 in order to avoid oversubscription of lower layer resources. Rate control and flow optimization into the subnet enables using buffers above layer 2 (which in the aggregate are generally much larger than lower layer buffers) to absorb large bursts of traffic, insulating the layer 2 components 120 within node 110, but also nodes in the subnet, e.g., nodes 315, 325, 335, from much of that burden and reducing layer 2 buffer sizes.

This partitioning further provides for node implementations that dedicate one or more processing cores (in multi-core nodes) to handling the input and output for the set of cores used for application processing (e.g., an asymmetric multi-processor (AMP) mode of operation). In this mode of operation, most of the functionality between the higher layer queues and the layer 2 transmit and receive hardware can be implemented in software that runs on the dedicated I/O core(s). For single processor or symmetric multi-processor (SMP) systems running general purpose operating systems (such as Microsoft Windows™ or Linux, available under the GNU General Public License from the Free Software Foundation, Inc.), the transmit scheduler 132, path rate control module 135, and L2CP module 140 may be implemented in a network interface card (NIC) or chipset level hardware/firmware. Such an embodiment may benefit from an additional path oriented level of queuing to the transmit scheduler from the higher layers.

Layer 2 Control Protocol

In one embodiment of the invention, a layer 2 control protocol (L2CP) provides control information about each individual path through a layer 2 subnetwork (“layer 2 subnet” or, simply, “subnet”) to higher layer functions, such as a path rate control function (PRC). L2CP, for example, supports the functionality for discovering and selecting path routes, collecting path and congestion information from the layer 2 subnet, and conveying such information to functions at the edges of the subnet. L2CP is, advantageously, a protocol that may be inserted into a standard network protocol stack between the network and link layers, presenting minimal disruption to any existing standards and providing interoperability with existing implementations.

Implementation of the protocol in accordance with an embodiment of the invention involves no changes to operating systems or upper layer protocols in the protocol stack or changes to existing link layer Media Access Control (MAC) packet formats, or packet header definitions. An implementation of the protocol involves changes to the interface between the upper protocol layers and the lower protocol layers (e.g. Network Interface Cards (NICs) and driver level program code), support for L2CP in the switches, and definition of a L2CP control packet format. However, it is contemplated that the protocol can be implemented such that layer 2 components that are L2CP aware interoperate with components that are not.

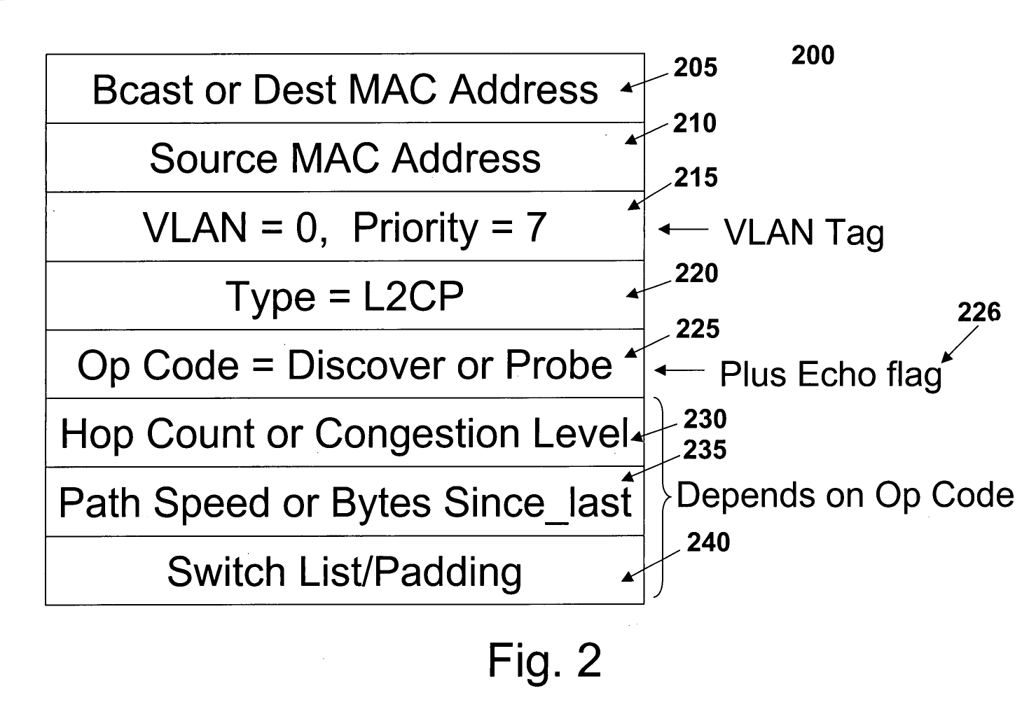

FIG. 2 depicts the format of L2CP messages (“packets”) 200 in accordance with an embodiment of the invention. A broadcast or destination Media Access Control (MAC) address field 205 identifies the destination of the message. A source MAC address field 210 identifies the source of the message. A Virtual Local Area Network (VLAN) tag 215 is used to specify the priority of the message, e.g., Priority =(0.7), but the VLAN identifier (VLAN ID, or VLAN) is set to 0 (or null). A type field 220 indicates an L2CP message. In one embodiment, a unique Ethernet type value is used to identify the protocol. An operation code field (Opcode) 225 specifies a type of L2CP message (“discover”, “discover echo”, “probe” or “probe echo”). An echo flag 226, included in an operation code (opcode) field in one embodiment, indicates whether the message is one of the two echo messages. Depending on the value of the opcode field, the next three fields 230, 235 and 240, are interpreted in one of two ways: discover and discover echo messages include hop count, path speed, and switch list fields, while probe and probe echo messages include congestion level, bytes-since-last (probe), and padding fields.

It should be noted that a minimum packet size, e.g., 64 bytes, leaves an amount of padding space in each probe packet. In one embodiment of the invention, this padding space could be used to carry additional congestion or flow control information specific to the functions interfacing to layer 2. For example, a router or line-card blade might include congestion information specific to its external ports.

The L2CP is implemented to support automatic path and route maintenance. In one embodiment, the protocol initially sequences through three phases: 1) routes-discovery, 2) route-selection/path-discovery, and 3) path-maintenance. The path-maintenance phase continues so long as the subnet topology is stable. Phases 1 & 2 can reoccur periodically or after a topology change, for example, in order to maintain appropriate path tables and switch filter databases (Ethernet switches include a filter database for storage of state and routing information with each entry typically associated with a specific VLAN and destination MAC address). In the same way that switch filter database entries are typically timed out after a sufficient period of inactivity, path table entries and their associated routes may be timed out and automatically re-established, in one embodiment of the invention.

Route Discovery Phase

The L2CP function module 140 operates independently on each layer 2 endpoint. For the routes-discovery phase, and with reference to FIGS. 2 and 3, each endpoint, e.g., 310, 320, 330, 340, 350, transmits a L2CP “broadcast discover” packet (with opcode field 225 =“discover”), specifying a well known broadcast MAC address 205 to announce its presence on the subnet 300. As the broadcast discover propagates through the subnet, each switch 315, 325, 335, 345 receives the packet and may use the source MAC address 210 therein to either create or update an entry in its respective filter database. In one embodiment, the first broadcast discover packet a switch receives from a particular endpoint, e.g., endpoint 310, corresponding to the source MAC address (i.e., the source endpoint) causes the switch to create a new entry in its filter database. As one example, a filter database entry can hold information for a number of ports, N, via which to reach a source endpoint (e.g., a normal spanning-tree protocol (STP) port and up to some number of alternative ports, n−1). This allows distributing the set of source/destination paths through the subnet n−1 ways across the set of available routes. (However, it should be understood that the number of alternative routes supported in a given switch is an implementation choice.)

Each switch that the broadcast discover packet traverses adds its identifying information, e.g., a switch ID, MAC address or some other such unique identifying information, to the switch list field 240 in the broadcast discover packet. A switch forwards the broadcast discover packet out all ports except the port via which it was received. Subsequent copies of the broadcast discover packet received at another port of the switch are used to update to the switch's filter database entry, but then are dropped to prevent broadcast loops and storms. The first broadcast discover packet that reaches an endpoint, e.g., endpoint 330, is used to create therein a new entry in path state table 150 (see FIG. 1) corresponding to the source endpoint. In this manner, all endpoints in the subnet discover the source endpoint that transmitted the broadcast discover packet is connected to the subnet. If all endpoints send broadcast discover messages (initially and then periodically), all endpoints discover all other endpoints in the subnet and each maintains a current path table entry for each of the others as long as their communications continue to be received.

Route-Select/Path-Discovery Phase

In the route-select/path-discovery phase, path table entries are initialized in response to the first transmission of data traffic to the corresponding destination endpoints (defined, for example, by that destination endpoint's MAC address, as learned from a broadcast discover packet received at the source endpoint from the destination endpoint). In one embodiment of the invention, the source endpoint precedes the first data transmission to a path with a L2CP “unicast discover”, or simply, “discover” packet, to the destination endpoint, specifying the MAC address of the destination endpoint in the destination MAC address field 205. As the discover packet traverses each switch, either the STP route, or one of the alternative routes, is selected for that path and recorded in the filter database maintained by the switch. The route may be selected in any number of ways, for example, by a load distribution/balancing algorithm.

The discover packet is then updated with path discovery information and forwarded to the port for the selected route. Thus, as the discover packet traverses the subnet, it establishes a selected route for the path and collects information about the path. At the destination endpoint, the discover packet is echoed directly back to the source endpoint (with echo flag 226 appropriately set). The path information in the discover echo packet is used to update a path state table entry corresponding to the destination endpoint in a path state table maintained by the source endpoint.

The unicast discover packet is updated at each switch to collect the hop count to the destination endpoint and the speed of the slowest link in the path in the forward direction. This information is maintained in fields 230 and 235, respectively. When the discover echo packet is received at the source endpoint, the L2CP function measures the round trip time (RTT) of the discover packet to derive a minimum one way delay (D_{Tmin}=˜RTT/2). Note that L2CP packets, including discovery packets, may be sent at the highest priority (e.g., field 215=priority 7) to minimize their delay through the subnet. The D_{Tmin}, hop count (N), and path speed (Ps) provide the initial state for that path and are used by the PRC algorithm to calculate rate control information, as discussed in more detail below.

Path-Maintenance Phase

During the path-maintenance phase, L2CP “probe” packets (with opcode field 225=“probe”) are periodically sent through each path to collect congestion level information and deliver such information to the path ingress L2CP function 140, where it is used to update the corresponding path state table entry (which, for example, is used by the PRC algorithm in controlling the rate of transmission of data traffic to the path). The L2CP “probe” process is illustrated in FIG. 3. Once a path of traffic flow (denoted by reference number 305) is initialized, the L2CP function (depicted as module 140 in FIG. 1, module 311 in FIG. 3) in the path egress endpoint, e.g., endpoint 330, periodically sends a probe packet 360 that traverses the subnet along the same path as the normal forward traffic, but in the opposite direction. In one embodiment, probe packets for a given path are sent at a fraction of the rate of the traffic received at the path egress endpoint 330.

In an alternative embodiment, the L2CP function at the path ingress endpoint, e.g., endpoint 310, periodically inserts probe packets into the forward data traffic stream to collect path congestion information in the forward direction. These probe packets get updated by any of the switches 315, 335, 325 or the egress endpoint 330 and echoed back to the ingress endpoint 310. This method is used, for example, where the forward and reverse paths through the subnet are different.

The initial information in each probe packet depends on whether probes are generated from the path ingresses (e.g. forward probes) or the path egresses (e.g. reverse probes). Each forward probe packet initially contains zero in the congestion level field 230 and the number of bytes sent since the last probe in the byte-since-last field 235. Each reverse probe packet initially contains information regarding the congestion level at the egress endpoint that issues the probe packet (specified, for example, as a percent of a receive buffer currently used) and the bytes received at the egress endpoint since the last probe. Regardless of whether probes are sent in the forward or reverse direction, the congestion level fields in a series of probe packets for a given path deliver the congestion level feedback signal to the ingress endpoint L2CP function 311.

As a probe packet passes through each switch in a path through the subnet, if the local congestion level 365 at a switch for the specified path, e.g., congestion 365b at switch 335 or congestion 365a at switch 315, is greater than the congestion level indicated in the probe packet, the switch replaces the congestion level in field 230 of the packet with its local congestion level. Thus, each reverse probe (or forward probe echo) packet received by an ingress endpoint L2CP function indicates the congestion level at the most congested point along the corresponding path. In one embodiment, the congestion level for a path is given by the following:
Cₚₐₜₕ=max{C₁, C₂, . . . , C_{N}}
where 1 to N represent the hops in the path. In one embodiment, C is in the range [0,˜150]. Each probe packet is used to update the corresponding path state in table 150 at the path ingress node 310 to reflect the current congestion level for the path. Although the congestion level could be derived by various methods, in one embodiment of the invention, the percentage of a per-port buffer allotment currently populated at a transmit port in a switch or a receive port of an egress endpoint is measured. (In a buffer sharing switch, the allotment may be the effective per-port buffer size and the percent of the allotment populated may be greater than 100%). This measurement of congestion works well if estimating the level of dispersion needed between packets entering a path in order to compensate for the congestion along the path. The dispersion estimate is directly usable to calculate a stride, or minimum time, between packets at the ingress endpoint, which may be more relevant to a transmit scheduler 132 than a rate estimate.

L2CP Messaging and Feedback Control

With reference to FIG. 1, in one embodiment, the L2CP function module 140 performs three basic functions, 1) control, 2) message generation (sending L2CP discover, probe, or corresponding echo, packets), and 3) message reception (receiving L2CP packets). The control function communicates with a higher layer interface 130 to learn when a data packet is posted by transmit scheduler 132 to a transmit queue 133 associated with a path that either has no corresponding entry in path state table 150 or the corresponding entry is not initialized. In one embodiment of the invention, given a limited size table with entries for only the most recently used paths, an indication that no entry exists may indicate this is the first data packet posted for the path since the previous entry was last evicted (in this case, a new entry for that path is placed in the path state table). In either case, a unicast discover message is transmitted via transmit interface 155a over the path to the destination endpoint. As discussed above, the egress L2CP function 140 echoes the discover packet, and when the discover echo packet is received at the ingress L2CP function for that path, the corresponding path state table entry is initialized with the hop count (N), path speed (Ps), and minimum delay (D_{Tmin}).

The message generation function creates or echoes L2CP packets (discover or probe) and sends them to the transmit interface 155a. The message reception function receives L2CP messages via receive interface 155b, extracts the fields from the received messages and passes the information to the control function for updating the corresponding path state table entries in table 150. The message generation function also echoes messages (when required) by first swapping the destination and source MAC addresses 205, 210, setting the echo flag 226, and then forwarding the message to transmit interface 155a.

Layer 2 Control Protocol in Support of Extended Spanning Tree Protocol Routing

In one embodiment of the invention, in addition to the layer 2 control protocol (L2CP) providing control information about each individual path through a layer 2 subnetwork (“layer 2subnet” or, simply, “subnet”) to the path rate control function (PRC), L2CP further provides support for extended Spanning Tree Protocol Routing (ESTR) in accordance with embodiments of the invention, using the same functionality for discovering and selecting path routes, collecting path and congestion information from the layer 2 subnet, and conveying such information to functions at the edges of the subnet.

As discussed above, the L2CP supports automatic path and route maintenance, using three phases: 1) routes-discovery, 2) route-selection/path-discovery, and 3) path-maintenance. Phases 1 and 2 reoccur periodically or after a topology change, for example, in order to maintain appropriate path tables and switch filter databases.

Network Topology Including a Spanning Tree

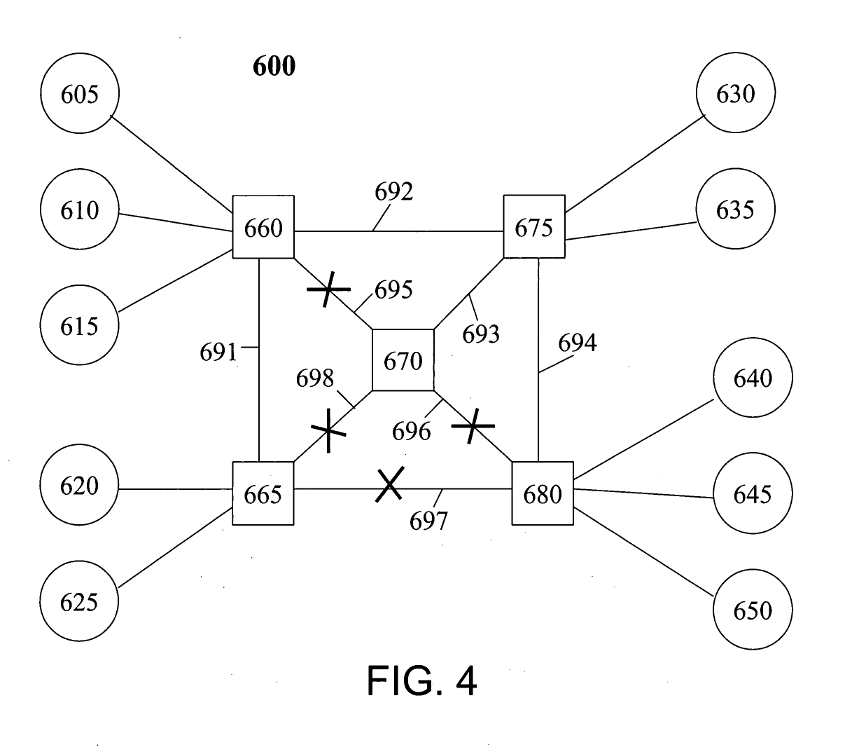

FIG. 4 illustrates a simplified mesh (non-tree) network topology 600 in which an embodiment of the invention may be embodied. Five switches 660, 665, 670, 675 and 680, interconnected by eight links 691-698, are employed to provide interconnect bandwidth and redundant routing paths. To each switch is coupled one or more endpoints 605-650. In the example network, switch 675 is selected as the root node for the Spanning Tree Protocol (STP). STP configures a tree topology, with switch 675 at the root. Switch 675 is connected via link 693 to switch 670, is connected via link 694 to switch 680, and via link 692 to switch 660, which in turn, is connected via link 691 to switch 665. Links 691, 692, 693 and 694 are enabled by STP for handling data traffic, while all other links 695, 696, 697 and 698 are put in the “blocked” state by the STP, preventing data traffic from being forwarded to those links, so that there is at most one link between a switch and any other switch in the network over which data traffic is transmitted in accordance with the STP. Links in the “blocked” state are alive and capable of carrying traffic but are avoided by the switch routing mechanism. However, as described below, in accordance with an embodiment of the invention, the STP is extended so that all the links in the network that are alive (i.e. not in the “disabled” state) may be used to transmit unicast data packets, even those links 695-698 that are “blocked” by the STP. This can be achieved without any negative side affects, such as deadlock, by ensuring that all unicast traffic between any two endpoint nodes (605 to 625 and 630 to 650) follows the same path through the network. It should be noted that the above described network architecture may be implemented in a switching fabric, datacenter, cluster, or blade system interconnect, or a Storage Area Network (SAN) as well.

Route Discovery Phase

The L2CP function module 140 operates independently on each layer 2 endpoint 605-650. For the routes-discovery phase, and with reference to FIGS. 2, 4 and 6, each endpoint transmits at 810 a L2CP broadcast discover packet (BDP) (with opcode field 225=“discover”), specifying a broadcast MAC address 205 to announce the endpoint node's presence on the subnet 600. As the BDP propagates through the subnet, at 820, each switch receives the packet at an input port, and if at 830 the port at which the BDP is received is not in the “disabled” state, (i.e. it may be in any other state including the “blocked” state) and if at 850 the BDP is the first copy received by the switch, the switch at 860 adds identifying information about the switch, for example, a switch identifier (ID), to a switch list field 240 in the BDP. Additionally, the switch updates the hop count field 230 in the BDP.

At 870, the switch then uses the source MAC address 210 in the BDP to either create or update an entry in its respective filter database, depending on whether or not an entry corresponding to the source MAC address 210 already exists in the filter database. The filter database entry indicates the port on which the BDP was received, and whether that port is a spanning-tree route or an alternative route to the source endpoint.

The first packet a switch receives from a particular endpoint corresponding to the source MAC address (i.e., the source endpoint) causes the switch to create a new entry in its filter database. As one example, a filter database entry can hold information for a number of ports, N, via which to reach a source endpoint (e.g., a normal spanning-tree protocol (STP) port and up to some number of alternative ports, n−1). This allows distributing the set of source/destination paths through the subnet n−1 ways across the set of available routes.

In this manner, each switch that the broadcast discover packet traverses adds its identifying information, e.g., a switch ID, MAC address, or some other such unique identifying information, to the switch list field 240 in the broadcast discover packet. The switch then forwards at 880 the broadcast discover packet out all ports except the port via which it was received and which are not placed in the disabled or blocked state by the STP.

Subsequent copies of the broadcast discover packet received at another port of the switch are used to update to the switch's filter database entry, but then are dropped to prevent broadcast loops and storms. The first broadcast discover packet that reaches an endpoint is used to create therein a new entry in that endpoint's path state table 150 (see FIG. 1) corresponding to the source endpoint. In this manner, all endpoints in the subnet discover the source endpoint that transmitted the broadcast discover packet is connected to the subnet, and create and maintain a path table entry for the source endpoint.

If at 830, it is determined by the switch that the port on which the BDP is received is in the “disabled” state or if at 850 the switch has already received a copy of the BDP (as evidenced by the switch's identifying information being present in the BDP's switch list), the packet is discarded to prevent broadcast loops and storms.

If the BDP traverses a switch that does not implement L2CP, the packet is broadcast along all spanning-tee routes in accordance with standard STP. If a copy of the BDP reaches an endpoint of the layer 2 subnet that does not support or implement L2CP, the packet will be forwarded to an upper layer protocol, where it will be discarded due to, for example, a unrecognized protocol type 220.

Thus, as a BDP propagates through the subnet, from the PRCI of a source endpoint to the PRCI of each reachable destination endpoint, all possible routes back to the source are recorded in the filter databases of the switches in the subnet. To limit the amount of memory utilized by the filter databases in the switches, especially if the switches are configured with a large number of ports, the number of alternative routes recorded to the database may be limited to only the N lowest hop count routes. Similarly, all endpoints attached to the subnet announce their presence using a BDP, so that each endpoint is aware of all the other endpoints that it can reach, and each switch in the subnet is aware of up to N different routes through which each destination endpoint can be reached from that switch.

Route-Select/Path-Discovery Phase

Embodiments of the invention provide for switches in the subnet to assign to a path between a source and destination endpoint a particular unicast route through the subnet. That is, unicast data packets traverse the particular unicast route selected by the switches (even though the route may include links that were put in the “blocked” state by the STP), while broadcast and multicast data traffic must only follow routes put in the “forwarding” state by the STP.

In the route-select/path-discovery phase, path table entries are initialized in response to the first transmission of data traffic to the corresponding destination endpoint (defined, for example, by that destination endpoint's MAC address, as learned from a broadcast discover packet received at the source endpoint from the destination endpoint). With reference to FIG. 7, in one embodiment of the invention, at 710, a source endpoint, and more particularly, the PRCI in the source endpoint, precedes the first data transmission to a path with a L2CP “unicast discover packet” (UDP), or simply, “discover” packet, to the destination endpoint, specifying the MAC address of the destination endpoint in the destination MAC address field 205. At 720, the UDP is received at an input port of a switch in the subnet. In one embodiment, in which the path follows the same route in both directions, the filter database entry for the source MAC address of the discover packet is updated in the switch to identify the input port as the unicast route back to the source endpoint from the switch.

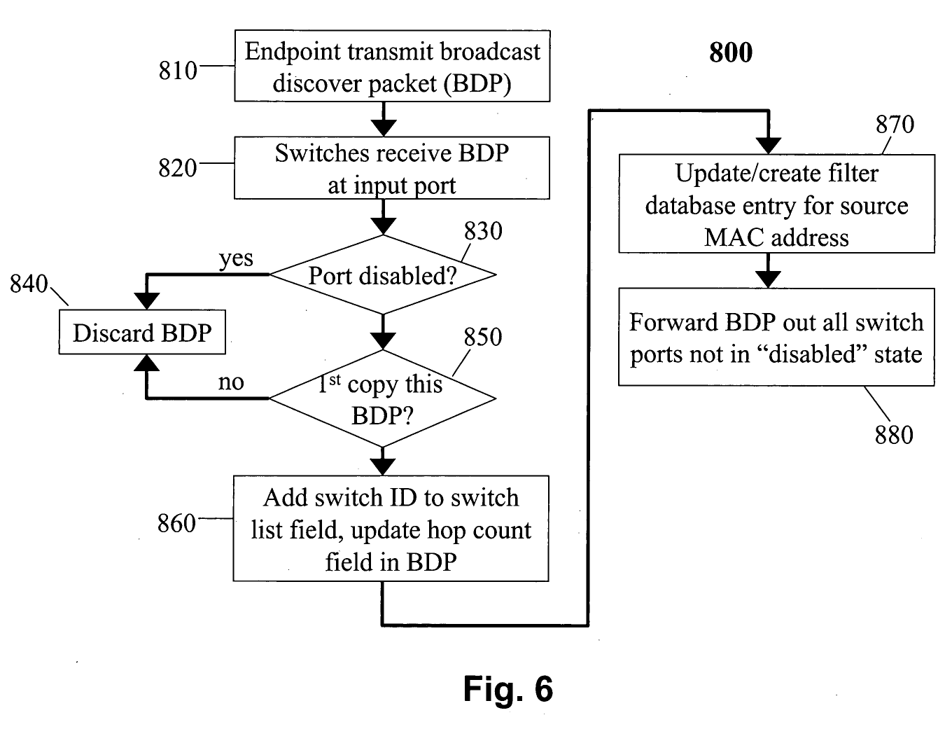

The switch selects at 730 either the STP route, or one of the alternative routes, as the path to the destination endpoint specified in the UDP. For example, in FIG. 6, if switch 665 receives a UDP from source endpoint 625 specifying a destination endpoint of 635, the switch selects one of links 691, 698 or 697 as the path to destination endpoint 635, even though links 697 and 698 are in the “blocked” state according to the spanning-tree.

The route may be selected according to any suitable algorithm. For example, the route may be selected by calculating the lower cost route where the cost for each route is based on the number of paths (e.g., load) currently assigned to it. In this manner, each time a path is assigned to a route, the cost of the route is increased, thus decreasing the probability it will be selected next and causing the assignment of paths to routes to be load balanced across the set of available routes. In addition, or as an alternative, the hop count for each route may be factored into the cost calculation so that the load balancing will tend to load “shorter” routes with more path assignments but still distribute the path assignments across N available routes.

At 750, the switch updates the filter database entry for the destination MAC address specified in the discover packet to indicate the selected output port (e.g., route) to the destination endpoint assigned to the destination MAC address. At 740, the switch transmits the UDP from the output port corresponding to the selected route to the destination endpoint.

In one embodiment, the discover packet is updated with path discovery information and then forwarded to the switch's port for the selected route. Thus, as the discover packet traverses the subnet, it establishes a selected route for the path and collects information about the path. At the destination endpoint, the discover packet is echoed directly back to the source endpoint (with echo flag 226 appropriately set). The path information in the discover echo packet is used to update a path state table entry corresponding to the destination endpoint in a path state table maintained by the source endpoint.

The unicast discover packet is updated at each switch to collect the hop count to the destination endpoint and the speed of the slowest link in the path in the forward direction. This information is maintained in fields 230 and 235, respectively. When the discover echo packet is received back at the original source endpoint, the L2CP function measures the round trip time (RTT) of the discover packet to derive a minimum one way delay (D_{Tmin}=˜RTT/2). The D_{Tmin}, hop count (N), and path speed (Ps) provide the initial state for that path and are used by the PRC algorithm at the source endpoint to calculate rate control information, as discussed above.

Thus, as the unicast discover packet (UDP) traverses the subnet, it establishes the route from the source endpoint to the destination endpoint for unicast communications. In one embodiment, the process also establishes the route for unicast traffic from the destination endpoint back to the source endpoint. Alternatively, the forward and reverse unicast routes may differ by performing a separate route select operation in each direction, using the same process as outlined above with respect to FIG. 7.

If a UDP happens to traverse a switch that in unaware of L2CP packets, the switch will forward the packet along the established spanning-tree route. If the UDP reaches a non-L2CP aware layer 2 endpoint, the packet will be forwarded to an upper layer protocol where it will be discarded due to an unrecognized protocol type 220.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention can be downloaded as a computer program transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the invention. These references are not necessarily all referring to the same embodiment. Furthermore, the particular features, structures or characteristics may be combined as suitable in one or more embodiments of the invention.

What is claimed is:

1. A method comprising:
receiving at a first port of a switch in a network a discover packet specifying an address of an endpoint in the network;
selecting one of a spanning-tree-protocol (STP) route or an alternate route from the switch to the endpoint; and
forwarding the discover packet to a second port of the switch corresponding to the selected route.

2. The method of claim 1, further comprising updating an entry in a data structure in the switch for the address specified in the discover packet to indicate the second port of the switch corresponding to the selected route.

3. The method of claim 1, wherein the discover packet is a unicast layer two control protocol packet.

4. The method of claim 1, wherein the address of the endpoint is a destination Media Access Control (MAC) address.

5. The method of claim 1, wherein the alternate route is a redundant route to the endpoint.

6. The method of claim 5, wherein the redundant route is a blocked STP route.

7. The method of claim 1, wherein selecting one of the STP route or alternate route comprises selecting one of the STP route or alternate route according to a load-balancing algorithm.

8. The method of claim 1, wherein selecting the route comprises selecting the route with a lowest cost to the endpoint.

9. The method of claim 8, wherein the cost of a route is a function of the number of paths assigned to the route.

10. The method of claim 8, wherein the cost of a route is a function of whether the route is also a route from the switch to one or more other endpoints in the network.

11. The method of claim 1, wherein selecting a route comprises selecting the route having the shortest path to the endpoint.

12. The method of claim 11, wherein the shortest path is based on a hop count from the switch to the endpoint.

13. The method of claim 1, wherein the discover packet further specifies an address of a second endpoint in the network, the method further comprising:
updating an entry in a data structure in the switch for the second endpoint's address to indicate the first port of the switch corresponds to a route from the switch to the second endpoint.

14. The method of claim 1, wherein the second endpoint is a source endpoint in the network.

15. The method of claim 1, further comprising:
receiving at the first port of the switch a broadcast discover packet (BDP) specifying an address of an endpoint that transmitted the BDP;
updating the BDP with identifying information for the switch; and
forwarding the BDP out all ports of the switch.

16. The method of claim 15, further comprising creating or updating an entry in a data structure in the switch for the address of the endpoint that transmitted the BDP to indicate the first port on which the BDP was received.

17. The method of claim 16, wherein the entry further to indicate whether the first port corresponds to the STP route or the alternate route.

18. An article of manufacture, comprising:
an electronically accessible medium including instructions that when executed by a switch in a network cause the switch to:
receive at a first port of the switch a unicast discover packet (UDP) specifying a destination address of an endpoint in the network;
select one of an open spanning-tree-protocol (STP) route or a blocked STP route from the switch to the endpoint;
forward the UDP to a second port of the switch corresponding to the selected route; and
update an entry in a data structure in the switch for the destination address specified in the UDP to indicate the second port of the switch corresponding to the selected route.

19. The article of manufacture of claim 18, wherein the electronically accessible medium further includes instructions that cause the switch to select the one route according to a load-balancing algorithm.

20. The article of manufacture of claim 18, wherein the electronically accessible medium further includes instructions that cause the switch to select the one route according to a lowest cost to the endpoint.

21. A system, comprising:
an Ethernet-based storage area network comprising a plurality of switches, each switch to receive via an electronically accessible medium instructions that when executed by the switch in Ethernet-based storage area network cause the switch to:
receive at a first port of the switch a unicast discover packet (UDP) specifying a destination address of an endpoint in the network;
select one of an open spanning-tree-protocol (STP) route or a blocked STP route from the switch to the endpoint;
forward the UDP to a second port of the switch corresponding to the selected route; and
update an entry in a data structure in the switch for the destination address specified in the UDP to indicate the second port of the switch corresponding to the selected route.

22. The system of claim 21, wherein the electronically accessible medium further includes instructions that cause the switch to select the one route according to a load-balancing algorithm.

23. The system of claim 21, wherein the electronically accessible medium further includes instructions that cause the switch to select the one route according to a lowest cost to the endpoint.
